(19) United States
(12) Patent Application Publication
(10) Pub. No.: US 2026/0243205 A1
(43) Pub. Date: Aug. 20, 2026

(54) Method for Controlling an Internal Combustion Engine, Control Device, Internal Combustion Engine, and Motor Vehicle

(71) Applicant: Bayerische Motoren Werke Aktiengesellschaft, Muenchen (DE)

(72) Inventors: Peter Mueller, Muenchen (DE); Stefan Graf, Lautrach (DE); Sebastian Mai, Groebenzell (DE); Christian Moeller, List auf Sylt (DE); Stephan Ramatschi, Zorneding (DE); Carsten Marx, Dachau (DE); Andreas Witt, Muenchen (DE); Johannes Geiger, Oberschleissheim (DE)

(21) Appl. No.: 19/157,633

(22) PCT Filed: Feb. 9, 2024
(86) PCT No.: PCT/EP2024/053334

§ 371 Date: Aug. 18, 2025

(30) Foreign Application Priority Data
Feb. 28, 2023 (DE) 10 2023 104 885.6

(51) Int. Cl. F02D 13/02; F02D 41/00; F02D 41/14

(52) U.S. Cl. CPC F02D 13/0269; F02D 41/0007; F02D 41/1446

(57) ABSTRACT

A method operates an internal combustion engine in a first operating mode, a second operating mode and a third operating mode, each depending on whether respective first, second or third criteria are met. In the first operating mode, proceeding from top dead center of the crankshaft and measured in a working direction of rotation of the crankshaft, closure of the intake valve is fully completed at a first crankshaft angle at a bottom dead center position of the crankshaft. In the second mode, proceeding from top dead center, closure of the intake valve is fully completed at a second crankshaft angle, smaller than the first crankshaft angle, before the bottom dead center position. In the third mode, proceeding from top dead center, closure of the intake valve is fully completed at a third crankshaft angle which is smaller than the second crankshaft angle, before the bottom dead center position.

The present application is the U.S. national phase of PCT Application PCT/EP2024/053334 filed on Feb. 9, 2024, which claims priority of German patent application No. 10 2023 104 885.6 filed on Feb. 28, 2023, the entire contents of which are incorporated herein by reference.

### TECHNICAL FIELD

The present disclosure relates to the field of internal combustion engines, and more particularly, control of internal combustion engines.

### BACKGROUND

There is generally a demand to minimize pollutant emissions throughout the operation, that is to say in all operating states, of internal combustion engines, and to provide means for enabling internal combustion engines to be operated with lower emissions at all times. For this purpose, it is presently sought to enable a combustion operation in the combustion chambers of an internal combustion engine to take place with a stoichiometric fuel-air ratio λ=1 at all times. It is also known—for example from DE 44 80 333 T1, DE 603 01 093 T2 or 3 620 635 A1—to control an intake valve drive such that the corresponding intake valve is fully closed already during a charging stroke (that is to say long before the associated crank pin of a crankshaft of the internal combustion engine reaches its bottom dead center). In this way, in the case of a structurally defined compression ratio, a degree of filling of the of this are improved utilization of the expansion energy in the working stroke and consequently an increase in thermodynamic efficiency, a reduced knocking tendency, the possibility of advancing an ignition time at full load, and a reduced exhaust gas temperature. To compensate for the performance deficit that arises when using this principle (known to a person skilled in the field of internal combustion engines as the Miller cycle), use is made of charge air compressors (for example exhaust gas turbochargers, superchargers etc.), by means of which higher charge air pressures can be provided in relation to conventionally operated internal combustion engines with charge air supercharging.

In modern internal combustion engines, the Miller cycle is already used when a rotational speed and a load of the internal combustion engine and a charge air pressure allow, or do not oppose, the use of the Miller cycle. This does have the effect that the exhaust gas is efficiently cooled at an early point in time, whereby specified temperature limits of components of the internal combustion engine that come into contact with the exhaust gas, or the peripheral components and/or assemblies of said internal combustion engine, are not exceeded. At the same time, however, such early use of the Miller cycle leads to increased load on components, in particular on charge air compressors, of the internal combustion engine, even if the exhaust gas temperature without the Miller exhaust gas cooling effect would not yet be critical. There is therefore a conflict of aims between the desire to achieve the advantages of the Miller principle and an increased load on components, in particular on charge air compressors, of the internal combustion engine when using the Miller principle.

There is a need, therefore, to operate an internal combustion engine particularly efficiently and with particularly low emissions.

### SUMMARY

At least some of the embodiments disclosed herein address the above-stated need, as well as others. Further possible refinements are disclosed in the claims, in the description and in the figures. Features, advantages and possible refinements that are presented in the description for one of the subjects of the independent claims are to be regarded, across categories and embodiments, at least analogously as features, advantages and possible refinements of the respective subjects of the other independent claims and of every possible combination of the subjects of the independent claims, optionally in conjunction with one or more of the dependent claims.

During fired operation of an internal combustion engine, the latter emits exhaust gas. Temperature limits are specified for the purposes of component protection for components of an internal combustion engine that come into contact with the exhaust gas, or the peripheral components and/or assemblies of said internal combustion engine. Som embodiments are based on the consideration that, during average overall use of the internal combustion engine—for example during the use of a motor vehicle, which has the internal combustion engine, by an end user—temperatures exceeding or coming close to the specified temperature limits are to be expected to occur very infrequently. To be able to at least alleviate the conflict of aims, described in the introduction, between the desire to be able to efficiently utilize the advantages of the Miller principle and the increased load on the components, in particular on a charge air compressor, of the internal combustion engine, the method according to the disclosure for controlling the internal combustion engine is proposed.

At least one embodiment is a control device, for example an engine control unit, for an internal combustion engine, wherein the control device is configured to carry out the method or to control the internal combustion engine in accordance with the method. Another embodiment is an internal combustion engine unit that has the internal combustion engine and the control device. The control device and the internal combustion engine are coupled or couplable to one another such that control signals provided by the control device result in an action by the internal combustion engine. A further embodiment is a motor vehicle that has the internal combustion engine of the internal combustion engine unit as a drive machine. When the internal combustion engine is in the intended installed state, it forms a constituent part of the motor vehicle, wherein a crankshaft of the internal combustion engine and a wheel of the motor vehicle are mechanically coupled or couplable to one another, for the transmission of power/torque, via one or more transmissions. Alternatively or in addition, the internal combustion engine forms a drive element for an electrical generator that is coupled or couplable to an electric drive machine, wherein a rotor of the electric drive machine is coupled or couplable to the wheel, for the transmission of power/torque, directly or via one or more transmissions. Accordingly, the motor vehicle may be a motor vehicle that can be propelled purely by combustion engine means, or may be a motor vehicle that can be propelled by hybrid electric means.

The method for controlling the internal combustion engine may be a computer-implemented method. In this case, the control device is configured to carry out the method. Another embodiment is a computer program which, when its program commands are executed by the control device, cause said control device to carry out the method and thus provide control signals for the internal combustion engine. A computer-readable storage medium can store the computer program.

The internal combustion engine is designed as a four-stroke reciprocating piston engine and has a crankshaft, a combustion chamber and an intake valve assigned to the combustion chamber. The internal combustion engine also has a charge air compressor for pre-compressing charge air for the internal combustion engine. The charge air compressor has a charge air compressor unit. The charge air compressor unit is in particular an exhaust gas turbocharger or a supercharger that can be driven mechanically by the crankshaft and/or electrically; combinations of two or more charge air compressors—in particular of different type-are conceivable. Further components required for a functional internal combustion engine, and possible structural configurations—in particular having two or more combustion chambers, each combustion chamber having two or more intake valves etc.—are familiar to a person skilled in the art, and will therefore be discussed in more detail only where necessary for the description. For the sake of a simple description, reference will be made herein only to one combustion chamber having an associated intake valve. Where it is stated herein that the intake valve is fully closed, this is to be understood to mean that an intake valve seat of the combustion chamber is completely blocked by an intake valve body of the intake valve such that a throughflow of a fluid (for example air etc.) is prevented. If two C more intake valves are provided per combustion chamber, the statement that the intake valve is fully closed is to be understood herein to mean that all intake valve seats of the combustion chamber are completely blocked such that a throughflow of fluid is prevented.

In the method, an intake valve drive of the internal combustion engine is controlled such that, during a charging stroke that takes place once every two full revolutions of the crankshaft, the intake valve is set fully into a closed position of the intake valve at different crankshaft angles, which the crankshaft passes through in an intended working direction of rotation, depending on a presently active operating mode of the internal combustion engine. In other words: in the particular charging stroke, a movement of the intake valve body in the direction of the closed position becomes no longer possible at an earlier or later point in time depending on the operating mode, because at the corresponding crankshaft angle the intake valve body is already fully seated in the intake valve seat and completely blocks said intake valve seat such that a throughflow is prevented. The intake valve drive may for example have a camshaft and/or a valve-specific linear drive. In any case, the intake valve drive is designed to adapt the control timing of the intake valve, that is to say to adjust an intake valve spread angle (described here in relation to a top dead center position of the crankshaft).

In a first of the operating modes, the intake valve is actuated by means of the intake valve drive such that, during a charging stroke of the internal combustion engine, a closure of the intake valve is fully completed at a first crankshaft angle KW1 (measured in the working direction of rotation proceeding from the top dead center position of the crankshaft) at a bottom dead center position of the crankshaft. In the first operating mode, the adjustment of the intake valve into its closed position is fully completed at the bottom dead center position, that is to say closer to the bottom dead center position than in the other two operating modes. In a second of the operating modes, the intake valve is actuated by means of the intake valve drive such that, during the charging stroke, the closure of the intake valve is fully completed at a second crankshaft angle KW2 (measured in the working direction of rotation proceeding from the top dead center position of the crankshaft). Here, the second crankshaft angle KW2 is less than the first crankshaft angle KW1; the adjustment of the intake valve into its closed position is fully completed closer to the top dead center position (that is to say earlier) than in the first operating mode. In a third of the operating modes, the intake valve is actuated by means of the intake valve drive such that, during the charging stroke, the closure of the intake valve is fully completed at a third crankshaft angle KW3 (measured in the working direction of rotation proceeding from the top dead center position of the crankshaft). Here, the third crankshaft angle KW3 is less than the second crankshaft angle KW2; the adjustment of the intake valve into its closed position is thus fully completed even closer to the top dead center position (that is to say even earlier) than in the second operating mode.

Each crankshaft angle KW1, KW2, KW3 is in particular an angle that lies in a crankshaft angle range [KW1], [KW2], [KW3] associated with the corresponding operating mode. All angle values in the first crankshaft angle range [KW1] are greater than all angle values in the second and in the third crankshaft angle range [KW2], [KW3], and all angles in the second crankshaft angle range [KW2] are greater than all angle values in the third crankshaft angle range [KW3]; the following applies:
KW1>KW2>KW3 and [KW1]>[KW2]>[KW3].

Thus, a closure of the intake valve is fully completed at the first crankshaft angle KW1, which lies in the first crankshaft angle range [KW1], in the first operating mode, is fully completed at the second crankshaft angle KW2, which lies in the second crankshaft angle range [KW2], in the second operating mode, and is fully completed at the third crankshaft angle KW3, which lies in the third crankshaft angle range [KW3], in the third operating mode.

In the method, the internal combustion engine is furthermore controlled such that it is operated in the first operating mode if or for as long as a first operating criterion is met. The first operating criterion may for example be met if the charge air that flows into the combustion chamber in the charging stroke has a charge air pressure, the value of which lies in a first specified charge air pressure value range comprising values from zero up to and including a first specified threshold charge air pressure value. Accordingly, the internal combustion engine is for example operated in the first operating mode if or for as long as the charge air is compressed at most up to the first specified threshold charge air pressure by means of the charge air compressor. Thus, the present charge air pressure is determined, and if its value lies within the first specified charge air pressure value range, the internal combustion engine continues to be operated in the first operating mode, because the first sub-criterion relating to the charge air pressure is met. The first specified threshold charge air pressure characterizes, for example, a charge air pressure at which a highest possible torque of the internal combustion engine, for which the internal combustion engine is designed, is delivered. This means that, according to the method, the internal combustion engine is operated in the first operating mode, in which the intake valve is set fully into the closed position at the first crankshaft angle KW1, until the internal combustion engine delivers the highest possible torque. The full torque can thus be delivered by the motor vehicle particularly quickly. This is because, the lower the charge air pressure, the better the response behavior, that is to say the more dynamic the driving operation of the motor vehicle is perceived to be by a user or driver.

Furthermore, the first operating criterion may for example be met if the present crankshaft rotational speed has a value that lies in a first specified rotational speed value range comprising values from zero, in particular from an idle rotational speed value, up to and including a first specified threshold rotational speed value. The rotational speed at which the crankshaft of the internal combustion engine is presently rotating is thus determined. If the corresponding rotational speed value lies within the first specified rotational speed value range, the internal combustion engine continues to be operated in the first operating mode, because the first sub-criterion relating to the crankshaft rotational speed is met.

The first operating criterion may furthermore be met if a present load of the internal combustion engine has a value that lies in a first specified load value range comprising values from zero up to and including a first specified threshold load value. The internal combustion engine therefore continues to be operated in the first operating mode if the sub-criterion relating to the load is met. For this purpose, the present load is determined. If the corresponding load value lies within the first specified load value range, the first sub-criterion relating to the load is met.

The first operating criterion may also be met if a present transmission ratio stage of a multi-ratio speed-transforming transmission coupled to the internal combustion engine has a value that lies in a first specified transmission ratio stage value range comprising values from zero up to and including a first specified threshold transmission ratio stage value. The presently selected and/or engaged transmission ratio stage is thus determined, and if the corresponding transmission ratio stage value lies within the first specified transmission ratio stage value range, the first sub-criterion relating to the transmission ratio stage is met, and therefore the internal combustion engine continues to be operated in the first operating mode.

Moreover, the first operating criterion may be met if a present traveling speed of a motor vehicle that has the internal combustion engine as a drive machine has a value that lies in a first specified speed value range comprising values from zero up to and including a first specified threshold speed value. The speed at which the motor vehicle is presently traveling is thus determined. If the corresponding speed value lies within the first specified speed value range, the internal combustion engine continues to be operated in the first operating mode, because the first sub-criterion relating to the traveling speed is met.

The first operating criterion may also be met if a present operating duration for which the internal combustion engine was most recently operated in the first operating mode without interruption has a value that lies in a first specified time value range comprising values from zero up to and including a first specified threshold operating time value. In other words, the length of time for which the internal combustion engine was most recently operated in the first operating mode without interruption is determined. If this time lies within the first specified time value range, the first sub-criterion relating to the operating duration is met, and the internal combustion engine continues to be operated in the first operating mode.

The first operating criterion may also be met if, at a location in the exhaust section of the internal combustion engine, an exhaust gas temperature is determined, the value of which lies in a first specified exhaust gas temperature value range comprising values from zero up to and including a first specified threshold exhaust gas temperature value. Accordingly, the internal combustion engine continues to be operated in the first operating mode if the first sub-criterion relating to the exhaust gas temperature is met. For this purpose, the present exhaust gas temperature at the corresponding location in the exhaust section is determined. If the corresponding exhaust gas temperature value lies within the first specified exhaust gas temperature value range, the first sub-criterion relating to the exhaust gas temperature is met.

One, some or all of the values described herein may in particular be modeled, for example by means of the control device of the internal combustion engine and/or by means of another control device (for example a transmission control unit etc.). Alternatively or in addition, one, some or all of said values may be measured, for example by means of a correspondingly configured and arranged sensor. For example, the exhaust gas temperature value may be determined by virtue of the exhaust gas temperature prevailing at the location in the exhaust section, or the corresponding exhaust gas temperature value, being modeled, for example by means of the control device of the internal combustion engine. Alternatively or in addition, the exhaust gas temperature value may be determined by virtue of the exhaust gas temperature being directly measured at the corresponding location in the exhaust section, for example by means of a temperature sensor. This applies analogously to the other values determined for the method or an embodiment thereof. The same value to be determined may be both measured and modeled, for example for redundancy or operational reliability reasons, for plausibility consideration, etc.

In particular, two or more of the aforementioned first sub-criteria must be present in order for the first operating criterion to be regarded as being met, and for the internal combustion engine to be operated in the first operating mode.

If or for as long as another, second operating criterion is met, the internal combustion engine is switched from the first into the second operating mode, in which the intake valve is set fully into the closed position at the second crankshaft angle KW2. The second operating criterion may for example be met if the charge air has a charge air pressure, the value of which lies in a second specified charge air pressure value range comprising values from but excluding the first specified threshold charge air pressure value up to and including a second specified threshold charge air pressure value. Thus, the present charge air pressure is determined, and if its value lies within the second specified charge air pressure value range and thus outside the first specified charge air pressure value range, the internal combustion engine is switched into the second operating mode, because the second sub-criterion relating to the charge air pressure is met.

The second operating criterion may furthermore be met if the present crankshaft rotational speed of the internal combustion engine has a value that lies in a second specified rotational speed value range comprising values from but excluding the first specified threshold rotational speed value up to and including a second specified threshold rotational speed value. The rotational speed at which the crankshaft of the internal combustion engine is presently rotating is thus determined. If the corresponding rotational speed value lies within the second specified rotational speed value range and thus outside the first specified rotational speed value range, the internal combustion engine is switched into the second operating mode, because the second sub-criterion relating to the crankshaft rotational speed is met.

The second operating criterion may also be met if the present load of the internal combustion engine has a value that lies in a second specified load value range comprising values from but excluding the first specified threshold load value up to and including a second specified threshold load value. The internal combustion engine is therefore switched into the second operating mode if the second sub-criterion relating to the load is met. For this purpose, the present load is determined. If the corresponding load value lies within the second specified load value range and thus outside first specified load value range, the second sub-criterion relating to the load is met.

Moreover, the second operating criterion may be met if the present transmission ratio stage of the multi-ratio speed-transforming transmission has a value that lies in a second specified transmission ratio stage value range comprising values from but excluding the first specified threshold transmission ratio stage value up to and including a second specified threshold transmission ratio stage value. The presently selected and/or engaged transmission ratio stage is thus determined, and if the corresponding transmission ratio stage value lies within the second specified transmission ratio stage value range and thus outside the first specified transmission ratio stage value range, the second sub-criterion relating to the transmission ratio stage is met, and therefore the internal combustion engine is switched into the second operating mode.

It is also conceivable that the second operating criterion is met if the present traveling speed of the motor vehicle has a value that lies in a second specified speed value range comprising values from but excluding the first specified threshold speed value up to and including a second specified threshold speed value. The speed at which the motor vehicle is presently traveling is thus determined. If the corresponding speed value lies within the second specified speed value range and thus outside the first specified speed value range, the internal combustion engine is switched into the second operating mode, because the second sub-criterion relating to the traveling speed is met.

The second operating criterion may furthermore be met if a present operating duration for which the internal combustion engine was most recently operated in the first operating mode without interruption has a value that lies in a second specified time value range comprising values from but excluding the first specified threshold operating time value up to and including a second specified threshold operating time value. In other words, the length of time for which the internal combustion engine was most recently operated in the first operating mode without interruption is determined. If this time lies within the second specified time value range, that is to say outside the first specified time value range, the second sub-criterion relating to the operating duration is met, and the internal combustion engine is switched into the second operating mode.

The second operating criterion may also be met if, at a location in the exhaust section of the internal combustion engine, an exhaust gas temperature is determined, the value of which lies in a second specified exhaust gas temperature value range comprising values from but excluding the first specified threshold exhaust gas temperature value up to and including a second specified threshold exhaust gas temperature value. Accordingly, the internal combustion engine is switched into the second operating mode if the second sub-criterion relating to the exhaust gas temperature is met. For this purpose, the present exhaust gas temperature at the corresponding location in the exhaust section is determined. If the corresponding exhaust gas temperature value lies within the second specified exhaust gas temperature value range and thus outside the first specified exhaust gas temperature value range, the second sub-criterion relating to the exhaust gas temperature is met.

In particular, two or more of the aforementioned second sub-criteria must be present in order for the second operating criterion to be regarded as being met, and for the internal combustion engine to be switched into the second operating mode or operated in the second operating mode.

In the method, provision is made in particular for the internal combustion engine to be switched as early as possible into the second operating mode, in which it is operated in accordance with a Miller cycle of first Miller intensity. The exhaust gas temperature is thus advantageously reduced particularly early. This is because the Miller combustion process causes the effective compression ratio to be lowered, by virtue of a proportion of the charge air situated in the combustion chamber being firstly expanded—owing to the early closure of the intake valve—and then compressed again. The consequently reduced effective compression ratio results in a reduced knocking tendency. Earlier ignition angles can thus be set. The earlier the fuel-air mixture in the combustion chamber is ignited, the earlier the combustion commences, and thus the further the combustion has progressed at the time of opening of the exhaust valve. This results in a lower exhaust gas temperature. The components that interact with the exhaust gas—for example a turbine, which can be driven by the exhaust gas, of the charge air compressor, an exhaust gas aftertreatment device, etc.—thus come into contact with particularly cool exhaust gas, whereby undesirably high temperatures, in particular the attainment of the specified temperature limits, are effectively avoided. Furthermore, the switch from the first into the second operating mode is made neutrally in terms of torque. This means that the intake valve spread angle and the charge air pressure are adjusted whilst maintaining the present torque. Occupants of the motor vehicle therefore do not notice the switch in operating mode.

Only if a third operating criterion has been met, which is specified in particular for the purposes of component protection for components of the internal combustion engine that come into contact with the exhaust gas and/or the charge air, or the peripheral components and/or assemblies of said internal combustion engine, is the internal combustion engine switched from the second into the third operating mode, in which the intake valve is set fully into the closed position at the third crankshaft angle KW3. In particular, internal combustion engine is operated in the third operating mode only until such time as the third operating criterion is met. The third operating criterion may for example be met if the charge air has a charge air pressure, the value of which lies in a third specified charge air pressure value range comprising values from but excluding the second specified threshold charge air pressure value, and higher charge air pressure values. Thus, the present charge air pressure is determined, and if its value lies within the third specified charge air pressure value range and thus neither in the first nor in the second specified charge air pressure value range, the internal combustion engine is switched into the third operating mode, because the third sub-criterion relating to the charge air pressure is met.

The third operating criterion may furthermore be met if the present crankshaft rotational speed of the internal combustion engine has a value that lies in a third specified rotational speed value range comprising values from but excluding the second specified threshold rotational speed value, and higher rotational speed values. The rotational speed at which the crankshaft of the internal combustion engine is presently rotating is thus determined. If the corresponding rotational speed value lies within the third specified rotational speed value range and thus neither in the first nor in the second specified rotational speed value range, the internal combustion engine is switched into the third operating mode, because the third sub-criterion relating to the crankshaft rotational speed is met.

The third operating criterion may also be met if the present load of the internal combustion engine has a value that lies in a third specified load value range comprising values from but excluding second first specified threshold load value, and higher load values. The internal combustion engine is therefore switched into the third operating mode if the third sub-criterion relating to the load is met. For this purpose, the present load is determined. If the corresponding load value lies within the third specified load value range and thus neither in the first nor in the second specified load value range, the third sub-criterion relating to the load is met.

Moreover, the third operating criterion may be met if the present transmission ratio stage of the multi-ratio speed-transforming transmission has a value that lies in a third specified transmission ratio stage value range comprising values from but excluding the second specified transmission ratio stage value range, and higher transmission ratio stage values. The presently selected and/or engaged transmission ratio stage is thus determined, and if the corresponding transmission ratio stage value lies within the third specified transmission ratio stage value range and thus outside the first and the second specified transmission ratio stage value range, the third sub-criterion relating to the transmission ratio stage is met, and therefore the internal combustion engine is switched into the third operating mode.

It is also conceivable that the third operating criterion is met if the present traveling speed of the motor vehicle has a value that lies in a third specified speed value range comprising values from but excluding the second specified threshold speed value, and higher speed values. The speed at which the motor vehicle is presently traveling is thus determined. If the corresponding speed value lies within the third specified speed value range and thus neither in the first nor in the second specified speed value range, the internal combustion engine is switched into the third operating mode, because the third sub-criterion relating to the traveling speed is met.

The third operating criterion may also be met if present uninterrupted operating duration for which the internal combustion engine was most recently operated in the second operating mode without interruption has a value that lies in a third specified time value range comprising values from but excluding the second specified threshold operating time value, and higher operating time values. In other words, the length of time for which the internal combustion engine was most recently operated in the second operating mode without interruption is determined. If this time lies within the third specified time value range, that is to say outside the first specified time value range, the second sub-criterion relating to the operating duration is met, and the internal combustion engine is switched into the second operating mode.

The third operating criterion may also be met if, at a location in the exhaust section of the internal combustion engine, an exhaust gas temperature is determined, the value of which lies in a third specified exhaust gas temperature value range values from but excluding a second specified threshold exhaust gas temperature value, and higher exhaust gas temperature values. Accordingly, the internal combustion engine is switched into the third operating mode if the third sub-criterion relating to the exhaust gas temperature is met. For this purpose, the present exhaust gas temperature at the corresponding location in the exhaust section is determined. If the corresponding exhaust gas temperature value lies within the third specified exhaust gas temperature value range and thus outside and outside the second the first specified exhaust gas temperature value range, the third sub-criterion relating to the exhaust gas temperature is met.

In particular, two or more of the aforementioned third sub-criteria must be present in order for the third operating criterion to be regarded as being met, and for the internal combustion engine to be switched into the third operating mode or operated in the third operating mode. Provision may also be made for the internal combustion engine to be operated in the second operating mode for as long as the third operating criterion is met.

In particular, the values of the second specified charge air pressure value range are all higher than the highest value of the first specified charge air pressure range, the values of the second specified rotational speed value range are higher than the highest value of the first specified rotational speed value range, the values of the second specified load value range are all higher than the highest value of the first specified load value range, the values of the second specified transmission ratio stage value range are all higher than the highest value of the first specified transmission ratio stage value range, the values of the second specified speed value range are all higher than the highest value of the first specified speed value range, the values of the second specified time value range are all higher than the highest value of the first specified time value range, and/or the values of the second specified exhaust gas temperature value range are all higher than the highest value of the first specified exhaust gas temperature value range.

In the third operating mode, the internal combustion engine is operated in accordance with a Miller cycle of second Miller intensity, wherein the first Miller intensity of the second operating mode is lower than the second Miller intensity of the third operating mode. The charge air compressor must provide a higher charge air pressure in the third operating mode than in the second operating mode, as a result of which the charge air compressor is subjected to higher load than in the second operating mode. This is however accepted in order to sufficiently reduce the exhaust gas temperature in the third operating mode such that a maximum admissible exhaust gas temperature, at which the intended functioning of the corresponding components is still ensured, is adhered to or not exceeded. This means that, during the operation of the internal combustion engine, the maximum admissible exhaust gas temperature must imperatively be adhered to for component protection reasons, in order that the corresponding components do not sustain damage.

In particular, the sub-criteria are mutually exclusive. In other words, either the particular first sub-criterion is present or the particular second sub-criterion is present or the particular third sub-criterion is present. This is because the stated value ranges do not overlap.

In particular, in the method, provision is made for the operating modes not to overlap one another. In other words, the first operating mode is active when neither the second nor the third operating mode is active. The second operating mode is active when neither the first nor the third operating mode is active. The third operating mode is active when neither the first nor the second operating mode is active. In the method, provision is also made in particular whereby, when the third operating mode is active, a switch is made as soon as possible from the third into the second operating mode. In other words, the third operating mode is utilized only for lowering the exhaust gas temperature until the exhaust gas temperature is lower than the threshold exhaust gas temperature again. In other words, a switch is made from the third into the second operating mode when the exhaust gas temperature is lower than the threshold exhaust gas temperature again or falls below the threshold exhaust gas temperature. In particular, for a switch from the third into the second operating mode, a switching-back threshold temperature is specified which is lower than the threshold exhaust gas temperature and which is used instead of the threshold exhaust gas temperature for the switch from the third into the second operating mode. Switching back and forth between the second and the third operating mode therefore does not occur. The internal combustion engine is switched, in accordance with the method, into the first operating mode only if the prerequisites for the operation of the internal combustion engine in the second operating mode are still not present or are no longer present, that is to say for example when the charge air pressure falls below the threshold charge air pressure and/or a crankshaft rotational speed and/or a load of the internal combustion engine impede the use of the Miller cycle.

In particular, at least one intermediate operating mode for the operation of the internal combustion engine is conceivable. For example, in a first intermediate operating mode, the closure of the intake valve may take place later than in the second operating mode but earlier than in the first operating mode. Furthermore, a second intermediate operating mode is conceivable in which the closure of the intake valve takes place later than in the third operating mode but earlier than in the second operating mode. Between the first operating mode and the second operating mode and/or between the second operating mode and the third operating mode, there may be two or more different first and second intermediate operating modes (each of different Miller intensity). Particularly finely graduated adjustment of the Miller intensity is thus made possible. The method is transferable to the intermediate operating mode(s). In the presence of the first operating criterion (or of another/a further first operating criterion, optionally with further and/or other first sub-criteria), a switch may be made from the first operating mode into one of the first intermediate operating modes. From this, a switch may be made into a further one of the (first or second) intermediate operating stages, or the third operating mode, in the presence of the second operating criterion (or of another/a further second operating criterion, optionally with further and/or other second sub-criteria).

By means of the method, the internal combustion engine is operated particularly efficiently and with particularly low emissions, wherein, with a consistently stoichiometric fuel-air ratio λ=1, the exhaust gas temperature is kept below the threshold exhaust gas temperature. In particular, an enrichment of the fuel-air mixture (λ<1) for the purposes of cooling the exhaust gas is dispensed with, because this leads to increased pollutant emissions from the internal combustion engine and to a low conversion rate in a catalytic converter that is connected to the exhaust gas side of the internal combustion engine. It is also ensured, owing to the third operating state, that the thermal load on the components that interact with exhaust gas does not overshoot an admissible limit load. Present legal requirements that stipulate low limit values for pollutant emissions over an entire operating range of the internal combustion engine are adhered to. Furthermore, the motor vehicle that has the internal combustion engine as a drive machine is capable of higher driving performance. By means of the variably controllable intake spread, higher levels of power can be achieved in the first and second operating mode than in the third operating mode.

According to a further possible embodiment, the first crankshaft angle KW1 or the first crankshaft angle range [KW1] and the second crankshaft angle KW2 or the second crankshaft angle range [KW2] are spaced apart by a first angular interval of in particular greater than 10° or greater than 30°. Alternatively or in addition, the second crankshaft angle KW2 and the third crankshaft angle KW3, or the second crankshaft angle range [KW2] and the third crankshaft angle range [KW3], are spaced apart by a second angular interval of in particular greater than 5°. In particular, the first annular interval by which the crankshaft angles KW1, KW2 or the crankshaft angle ranges [KW1], [KW2] are spaced apart is greater than the second angular interval by which the crankshaft angles KW2, KW3 or the crankshaft angle ranges [KW2], [KW3] are spaced apart.

In one possible refinement, the switch between the first and the second operating mode and/or the switch between the second and the third operating mode is made steplessly. Particularly smooth switching between the operating modes of the internal combustion engine is thus ensured. Alternatively or in addition, the switch between the first and the second operating mode and/or the switch between the second and the third operating mode may be made by way of discrete steps.

In a further possible refinement of the method, the determination of the exhaust gas temperature comprises a determination of a first exhaust gas temperature at a first location in the exhaust section. The first location in the exhaust section is assigned to a turbine of an exhaust gas turbocharger of the internal combustion engine, in particular is arranged in/at an inflow region of the turbine, through which inflow region the exhaust gas of the internal combustion engine flows during the operation of said internal combustion engine in order to drive the turbine impeller of the turbine. Alternatively or in addition, the determination of the exhaust gas temperature comprises a determination of a second exhaust gas temperature at a second location in the exhaust section, said second location being assigned to an inflow end of an exhaust gas aftertreatment device, for example of a catalytic converter, of the internal combustion engine. The second location in the exhaust section is arranged in particular in/at an inflow channel portion of the exhaust gas aftertreatment device, through which portion the exhaust gas of the internal combustion engine flows during the operation of said internal combustion engine. Alternatively or in addition to the determination of the first and/or of the second exhaust gas temperature at the first or second location in the exhaust section, the determination of the exhaust gas temperature also comprises a determination of third exhaust gas temperature at a third location in the exhaust section. The third location in the exhaust section is assigned to an aftertreatment chamber, through which the exhaust gas flows, of the exhaust gas aftertreatment device, for example to a conversion chamber of the catalytic converter, for example is arranged in the aftertreatment chamber. The associated exhaust gas temperature may be measured, for example by means of correspondingly configured temperature sensors. Alternatively or in addition, one or more of the exhaust gas temperatures may be modeled, for example by means of the control device.

The first sub-criterion relating to the exhaust gas temperature is met if the value of the first exhaust gas temperature lies in the first exhaust gas temperature value range and/or if the value of the second exhaust gas temperature lies in the first exhaust gas temperature value range and/or if the value of the third exhaust gas temperature lies in the first exhaust gas temperature value range. In particular, an individual first exhaust gas temperature value range is provided for each location in the exhaust section. This means that, for example, a first exhaust gas temperature value range assigned to the first location in the exhaust section may comprise different exhaust gas temperature values than a first exhaust gas temperature value range assigned to the second location in the exhaust section. The second sub-criterion relating to the exhaust gas temperature is met if the value of the first exhaust gas temperature lies in the second exhaust gas temperature value range and/or if the value of the second exhaust gas temperature lies in the second exhaust gas temperature value range and/or if the value of the third exhaust gas temperature lies in the second exhaust gas temperature value range. In particular, an individual first and/or an individual second exhaust gas temperature value range is provided for each location in the exhaust section. This means that, for example, a first/second exhaust gas temperature value range assigned to the first location in the exhaust section may comprise different exhaust gas temperature values than a first/second exhaust gas temperature value range assigned to the second location in the exhaust section. This applies analogously to the other locations in the exhaust section. The third sub-criterion relating to the exhaust gas temperature is met if the value of the first exhaust gas temperature lies in the third exhaust gas temperature value range and/or if the value of the second exhaust gas temperature lies in the third exhaust gas temperature value range and/or if the value of the third exhaust gas temperature lies in the third exhaust gas temperature value range. In particular, an individual third exhaust gas temperature value range is provided for each location in the exhaust section. This means that, for example, a third exhaust gas temperature value range assigned to the first location in the exhaust section may comprise different exhaust gas temperature values than a third exhaust gas temperature value range assigned to the second location in the exhaust section. This applies analogously to the other locations in the exhaust section.

The exhaust gas temperatures at the various locations in the internal combustion engine are thus taken into account in a particularly exact manner. A plausibility check may also be provided. For example, if an implausibly high exhaust gas temperature, which lies above the first threshold exhaust gas temperature, is measured at the first location in the exhaust section, a switch from the second into the third operating mode may be dispensed with if an exhaust gas temperature which is plausible and lies below the second threshold exhaust gas temperature is measured at the second location in the exhaust section.

Further features can be found in the claims, the figures and the description of the figures. The features and combinations of features which are mentioned in the description above, and the features and combinations of features which are presented below in the description of the figures and/or which are only shown in the figures, may be used not only in the respectively specified combinations but also in other combinations or individually, without departing from the scope of the disclosure.

### BRIEF DESCRIPTION OF THE DRAWINGS

FIG. 1 shows a series of graphs of various aspects of an internal combustion engine along a common time axis.

FIG. 2 shows a series of the schematically illustrated crankshaft diagrams with the crankshaft in a plurality of positions.

### DETAILED DESCRIPTION

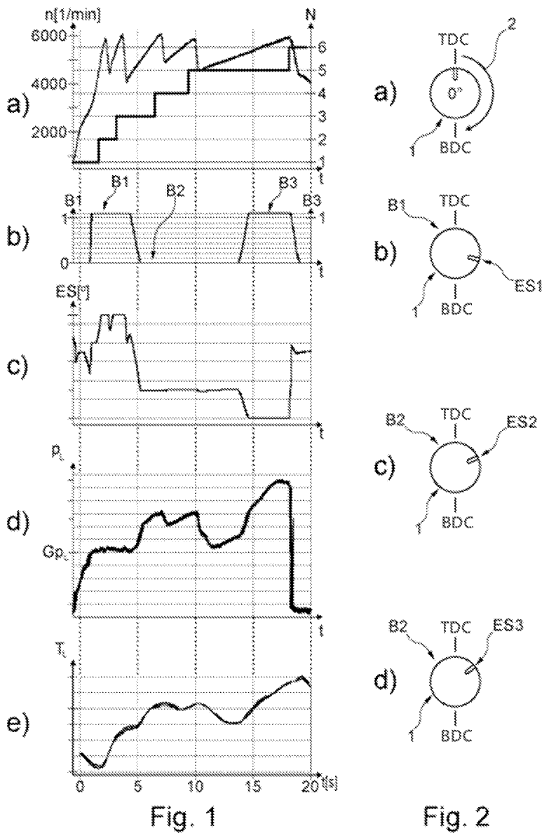

FIG. 1 shows, for a fired acceleration, lasting approximately 20 seconds, of an internal combustion engine which has a crankshaft and which is controlled by means of a method for controlling an internal combustion engine, and along a common time axis,
   a) a crankshaft rotational speed progression of the internal combustion engine and a transmission ratio stage progression of a multi-ratio speed-transforming transmission coupled to the crankshaft,
   b) an active-state progression of three operating modes of the internal combustion engine,
   c) a progression of an intake valve spread angle indicating the crankshaft angular position, relative to the top dead center position thereof, at which the intake valve is open with maximum lift,
   d) a charge air pressure progression and
   e) a charge air temperature progression,
FIG. 2 shows, for the purposes of illustrating the operating modes and the associated intake valve spread angles, the schematically illustrated crankshaft
   a) in a top dead center position,
   b) in a first angular position in which it has been moved out of the first top dead center position by a first crankshaft angle,
   c) in a second angular position in which it has been moved out of the first top dead center position by a second crankshaft angle,
   d) in a third angular position in which it has been moved out of the first top dead center position by a third crankshaft angle.

Below, a joint description will be given of a method for controlling an internal combustion engine, of a control device configured for carrying out the method, of an internal combustion engine unit comprising the internal combustion engine and the control device, and of a motor vehicle that has the internal combustion engine unit. In the figures, identical and functionally identical elements are denoted by the same reference signs.

The motor vehicle has the internal combustion engine unit, such that the internal combustion engine of the internal combustion engine unit forms a drive machine of the motor vehicle. The internal combustion engine unit has not only the internal combustion engine but also a control device, which has means for carrying out the method for controlling the internal combustion engine. Here, the control device provides control signals for the internal combustion engine, in particular for an intake valve drive of the internal combustion engine, wherein the internal combustion engine is configured to accept, as input control signals, the control signals provided by the control device. Accordingly, the internal combustion engine and the control device are coupled or couplable to one another for the transmission of control signals.

In the present case, the internal combustion engine is designed as a four-stroke reciprocating piston engine and has not only the intake valve drive but also a crankshaft 1, a combustion chamber and an intake valve assigned to the combustion chamber. The internal combustion engine furthermore has a charge air compressor, for example an exhaust gas turbocharger, for pre-compressing charge air that is to be fed to the combustion chamber. For charging of the combustion chamber with charge air or with a fuel-air mixture in a charging stroke during fired operation of the internal combustion engine, an exhaust side of the combustion chamber is sealingly closed by means of an exhaust valve, whereas an intake side of the combustion chamber is opened up, for an inflow of a fluid into the combustion chamber, by means of an intake valve that has been set at least partially into an open position. Here, for the movement of a reciprocating piston that is mounted so as to be translationally movable in the combustion chamber, the crankshaft 1 is rotated, in the intended working direction of rotation 2 (see FIG. 2a)), proceeding from the top dead center position TDC, indicated in FIG. 2 at 0°, of said crankshaft, in the direction of a bottom dead center position BDC, indicated in FIG. 2 at 180°, of the crankshaft 1. The charging stroke is followed by a compression stroke in which the crankshaft 1 is rotated in the working direction of rotation from the bottom dead center position BDC (180°) in the direction of the top dead center position TDC (360°). This is followed, in the subsequent full revolution of the crankshaft 1, by an expansion stroke (from 360° to 540°) and an exhaust stroke (from 540° to 720°=0°), and the four-stroke cycle begins anew.

FIG. 1a) shows, versus the time t, a progression of a crankshaft rotational speed n and a progression of transmission ratio stages N of a multi-ratio speed-transforming transmission coupled to the internal combustion engine, wherein the internal combustion engine is being accelerated in fired operation. Here, the internal combustion engine is controlled in accordance with the method.

FIG. 1b) illustrates those time segments of the acceleration process in which the internal combustion engine is operated in a first operating mode B1, in a second operating mode B2 and in a third operating mode B3. It can be seen that the operating modes B1, B2, B3 do not overlap. This means that the first operating mode B1 is active only when neither the second operating mode B2 nor the third operating mode B3 is active. The second operating mode B2 is active when neither the first operating mode B1 nor the third operating mode B3 is active. Consequently, the third operating mode B3 is active only when neither the first operating mode B1 nor the second operating mode B2 is active.

The operating modes B1, B2, B3 differ in particular by respectively associated intake valve spread angles ES, the progression of which versus the time t is plotted in FIG. 1c). The intake valve is fully open, that is to say set fully into an open position, for a different intake valve spread ES1, ES2, ES3 depending on the operating mode B1, B2, B3.

The intake valve spread angle ES is a crankshaft angle that is measured in the working direction of rotation 2 of the crankshaft 1 proceeding from the top dead center position TDC of the crankshaft 1. It follows from this that the intake valve is set fully into a closed position in the charging stroke at different crankshaft angles KW1, KW2, KW3 depending on the operating mode B1, B2, B3.

FIG. 2b), c) and d) visualize the intake valve spread angles ES1, ES2, ES3 at which the intake valve is open with maximum lift. It can be seen that, in the first operating mode B1, the intake valve is open to the maximum extent at a first intake valve spread angle ES1. The intake valve is thus situated fully in the closed position at a crankshaft angle KW1 of approximately 180°, that is to say approximately at the bottom dead center position BDC. In other words: in the first operating mode B1, a closing movement of the intake valve is fully completed at the bottom dead center position BDC, or when the crankshaft has assumed the first crankshaft angle KW1. At the first crankshaft angle KW1, an inflow of charge air into the combustion chamber is completely blocked. It is known that (for tolerance reasons such as valve play, and/or in order to utilize advantageous thermodynamic or fluid dynamic effects) the closure of the intake valve may be fully completed shortly before or shortly after the bottom dead center position, but at any rate in a close range around the bottom dead center position BDC, for example in a range of ±10° around the bottom dead center position BDC. The first intake valve spread angle ES1 therefore lies in particular in a first intake valve spread angle range [ES1], and the first crankshaft angle KWI consequently lies in particular in a first crankshaft angle range [KW1].

In the second operating mode B2, the intake valve is fully open at a second intake valve spread angle ES2, whereby the closure of the intake valve is completed earlier than in the first operating mode B1, that is to say at a second crankshaft angle KW2 and at any rate before the crankshaft 1 has assumed the first crankshaft angle KW1. The inflow of charge air into the combustion chamber is thus completely blocked already during the charging stroke. The internal combustion engine is thus operated in a Miller cycle of first Miller intensity.

The second intake valve spread angle ES2 may lie in a second intake valve spread angle range [ES2], which means that the second crankshaft angle KW2 may lie in a second crankshaft angle range [KW2]. Here, the first crankshaft angle KW1 or its angle range [KW1] and the second crankshaft angle KW2 or its angle range [KW2] are spaced apart by a first angular interval. This means that the first intake valve spread angle ES1 or its angle range [ES1] and the second intake valve spread angle ES2 or its angle range [ES2] may be spaced apart by the first angular interval. The first angular interval is greater than 10°, in particular greater than 30°. In the first Miller cycle or in the second operating mode B2, the closure of the intake valve ends for example 40° earlier than in the first operating mode B1.

In the third operating mode B3, the intake valve is fully open at a third intake valve spread angle ES3, whereby the closure of the intake valve is completed even earlier than in the second operating mode B2, namely at a third crankshaft angle KW3, whereby the internal combustion engine is then operated in a Miller cycle of second Miller intensity. The third crankshaft angle KW3 may lie in a third crankshaft angle range [KW3], and the third intake valve spread angle ES3 may lie in a third intake valve spread angle range [ES3]. Here, the second crankshaft angle KW2 or its angle range [KW2] and the third crankshaft angle KW3 or its angle range [KW3] are spaced apart by a second angular interval of greater than 5°. In this respect, the intake valve spread angle ranges [ES2], [ES3] may be spaced apart by the second angular interval. In the Miller cycle of second Miller intensity or in the third operating mode B3, the closure of the intake valve ends earlier than in the first operating mode B1 and earlier still than in the second operating mode B2. The effects associated with a Miller cycle are thus more pronounced in the Miller cycle of second intensity, that is to say in the third operating mode B3, than in the second operating mode B2; the second operating mode B2 has the first, low Miller intensity, and the third operating mode B3 has the second, high Miller intensity.

The charge air pressure of the charge air is determined in the method. The progression of the charge air pressure p_{L} during the fired acceleration under consideration here is plotted versus the time t in FIG. 1d). In particular, the crankshaft rotational speed and load with which the internal combustion engine is operated are determined. A present transmission ratio stage of a multi-ratio speed-transforming transmission coupled to the internal combustion engine, and a present traveling speed of the motor vehicle, are also determined. Furthermore, a present operating duration of the internal combustion engine and an exhaust gas temperature at a location in the exhaust section are determined. One, some or all of the values determined here—that is to say a charge air pressure value, a crankshaft rotational speed value (referred to for short as rotational speed value), a load value, a transmission ratio stage value, a traveling speed value (referred to for short as speed value), an operating duration value and an exhaust gas temperature value—may be modeled, for example by means of the control device of the internal combustion engine. Alternatively or in addition, one, some or all of said values may be measured, for example by means of correspondingly configured and arranged sensor. Here, for example, the exhaust gas temperature value is determined by virtue of the exhaust gas temperature prevailing at the location in the exhaust section, or the corresponding exhaust gas temperature value, being modeled by means of the control device.

The internal combustion engine is operated in the first operating mode B1 if or for as long as a first operating criterion is met. In the present example, the first operating criterion is met if one of first sub-criteria is met or if two or more of the first sub-criteria are met. Here, the first sub-criteria are as follows:
The charge air presently has a charge air pressure p_{L}, the value of which lies in a first specified charge air pressure value range comprising values from zero up to and including a first specified threshold charge air pressure value Gp_{L}.
The present crankshaft rotational speed n has a value that lies in a first specified rotational speed value range comprising values from zero, in particular from an idle rotational speed value, up to and including a first specified threshold rotational speed value.
The present load has a value that lies in a first specified load value range comprising values from zero up to and including a first specified threshold load value.
The present transmission ratio stage N of the multi-ratio speed-transforming transmission has a value that lies in a first specified transmission ratio stage value range comprising values from zero up to and including a first specified threshold transmission ratio stage value.
The present traveling speed has a value that lies in a first specified speed value range comprising values from zero up to and including a first specified threshold speed value.
A present operating duration for which the internal combustion engine was most recently operated in the first operating mode without interruption has a value that lies in a first specified time value range comprising values from zero up to and including a first specified threshold operating duration value.
At the location in the exhaust section of the internal combustion engine, the exhaust gas temperature is determined, the value of which lies in a first specified exhaust gas temperature value range comprising values from zero up to and including a first specified threshold exhaust gas temperature value.

In the method, the internal combustion engine is switched from the first operating mode B1 into the second operating mode B2 if another, second operating criterion is met. In the present example, the second operating criterion is met if one of second sub-criteria is met or if two or more of the second sub-criteria are met. Here, the second sub-criteria are as follows:
The charge air presently has a charge air pressure p_{L}, the value of which lies in a second specified charge air pressure value range comprising values from but excluding the first specified threshold charge air pressure value Gp_{L} up to and including a second specified threshold charge air pressure value.
The present crankshaft rotational speed has a value that lies in a second specified rotational speed value range comprising values from but excluding the first specified threshold rotational speed value up to and a second specified threshold rotational speed value.
The present load has a value that lies in a second specified load value range comprising values from but excluding the first specified threshold load value up to and including a second specified threshold load value.
The present transmission ratio stage of the multi-ratio speed-transforming transmission has a value that lies in a second specified transmission ratio stage value range comprising values from but excluding the first specified threshold transmission ratio stage value up to and including a second specified threshold transmission ratio stage value.
The present traveling speed has a value that lies in a second specified speed value range comprising values from but excluding the first specified threshold speed value up to and including a second specified threshold speed value.
The present operating duration for which the internal combustion engine was most recently operated in the first operating mode without interruption has a value that lies in a second specified time value range comprising values from but excluding the first specified threshold operating time value up to and including a second specified threshold operating time value.
At the location in the exhaust section, an exhaust gas temperature is determined, the value of which lies in a second specified exhaust gas temperature value range comprising values from but excluding the first specified threshold exhaust gas temperature value up to and including a second specified threshold exhaust gas temperature value.

The internal combustion engine is thus operated in the first operating mode B1 for as long as it is not the case that one or more of the second sub-criteria is satisfied, for example for as long as the charge air pressure p_{L} is lower than the threshold charge air pressure Gp_{L}. Provision is made for the internal combustion engine to be switched into the second operating mode B2 as early as possible, and for the internal combustion engine to be operated in the second operating mode B2 for as long as possible. It can be seen from FIG. 1d) that the charge air compressor delivers a higher charge air pressure in the second operating mode B2 than in the first operating mode B1. Here, the switch from the first operating mode B1 into the second operating mode B2 and vice versa is made steplessly. It is alternatively conceivable that the switch from the first operating mode B1 into the second operating mode B2 and vice versa is made by way of discrete steps.

In the method, the internal combustion engine is switched from the second operating mode B2 into the third operating mode B3 only when required for component protection reasons. For this purpose, a third operating criterion is provided, wherein the internal combustion engine is switched from the second operating mode B2 into the third operating mode B3, or is operated in the third operating mode B3, if third operating criterion is satisfied. In the present example, the third operating criterion is met if one of third sub-criteria is met or if two or more of the third sub-criteria are met. Here, the third sub-criteria are as follows:
The charge air has a present charge air pressure p_{L}, the value of which lies in a third specified charge air pressure value range comprising values higher than but excluding the second specified threshold charge air pressure value Gp_{L}.
The present crankshaft rotational speed has a value that lies in a third specified rotational speed value range comprising values higher than but excluding the second specified threshold rotational speed value.
The present load has a value that lies in a third specified load value range comprising values higher than but excluding second first specified threshold load value.
The present transmission ratio stage of the multi-ratio speed-transforming transmission has a value that lies in a third specified transmission ratio stage value range comprising values higher than but excluding the second specified threshold transmission ratio stage value.
The present traveling speed has a value that lies in a third specified speed value range comprising values higher than but excluding a second specified threshold speed value.
The present operating duration for which the internal combustion engine was most recently operated in the second operating mode without interruption has a value that lies in a third specified time value range comprising values higher than but excluding the second specified threshold operating duration value.
At the location in the exhaust section, an exhaust gas temperature is determined, the value of which lies in a third specified exhaust gas temperature value range comprising values higher than but excluding the second specified threshold exhaust gas temperature value.

For example, if the determined exhaust gas temperature is higher than a specified threshold exhaust gas temperature, the internal combustion engine is switched into the third operating mode B3. In particular, the internal combustion engine is switched back into the second operating mode B2 as soon as the exhaust gas temperature allows this again, that is to say as soon as the determined exhaust gas temperature at the corresponding location in the exhaust section falls or has fallen below a specified threshold exhaust gas temperature again. In the present case, for the switch from the third operating mode B3 into the second operating mode B2, a switching-back threshold temperature is specified which is lower than the threshold exhaust gas temperature and which is used instead of the threshold exhaust gas temperature for the switch from the third operating mode B3 into the second operating mode B2. Here, the switch from the second operating mode B2 into the third operating mode B3 and vice versa is made steplessly. It is alternatively conceivable that the switch from the second operating mode B2 into the third operating mode B3 and vice versa is made by way of discrete steps.

The internal combustion engine may furthermore be operated in a first intermediate operating mode which is characterized by an intake valve spread angle ES which is smaller than the first intake valve spread angle ES1 but greater than the second intake valve spread angle ES2. It follows from this that, in the first intermediate operating mode, the closure of the intake valve is completed at a crankshaft angle which is smaller than the first crankshaft angle KW1 and greater than the second crankshaft angle KW2. The internal combustion engine may also be operated in a second intermediate operating mode which, in particular, is characterized by an intake valve spread angle ES which is smaller than the second intake valve spread angle ES2 and greater than the third intake valve spread angle ES3. Thus, in the second intermediate operating mode, the closure of the intake valve is completed at a crankshaft angle which is smaller than the second crankshaft angle KW2 but greater than the third crankshaft angle KW3. Two or more first and two or more second intermediate operating modes are possible. The Miller intensity can be set particularly exactly in accordance with requirements by switching into one or more of the intermediate operating modes (for example first operating mode B1—first intermediate operating mode-further first intermediate operating mode(s)—second operating mode B2—second intermediate operating mode-further second intermediate operating mode(s)—third operating mode B3).

In the present case, a first exhaust gas temperature is determined at a first location in the exhaust section, a second exhaust gas temperature is determined at a second location in the exhaust section, and a third exhaust gas temperature is determined at a third location in the exhaust section. The first location in the exhaust section is assigned to a turbine of the exhaust gas turbocharger, for example is arranged in/at an inflow region of the turbine, and is specified for the purposes of component protection for the turbine. An inflow end of an exhaust gas aftertreatment device, for example of a catalytic converter, of the internal combustion engine is assigned to the second location in the exhaust section, and is arranged in particular in/at an inflow channel portion of the exhaust gas aftertreatment device. A second threshold exhaust gas temperature is specified for the purposes of component protection for the exhaust gas aftertreatment device. The third location in the exhaust section is assigned to an aftertreatment chamber, through which the exhaust gas flows, of the exhaust gas aftertreatment device, for example to a conversion chamber of the catalytic converter, for example is arranged in the aftertreatment chamber. A third threshold exhaust gas temperature is specified for the purposes of component protection for the aftertreatment chamber.

Here, an individual first, an individual second and an individual third exhaust gas temperature value range is assigned to each location in the exhaust section. Here, the first sub-criterion relating to the exhaust gas temperature is met if the value of the first exhaust gas temperature and/or the value of the second exhaust gas temperature and/or the value of the third exhaust gas temperature lies in the correspondingly assigned one of the individual first exhaust gas temperature value ranges. Here, the second sub-criterion relating to the exhaust gas temperature is met if the value of the first exhaust gas temperature and/or the value of the individual second exhaust gas temperature and/or the value of the third exhaust gas temperature lies in the correspondingly assigned one of the second exhaust gas temperature value ranges. Here, the third sub-criterion relating to the exhaust gas temperature is met if the value of the first exhaust gas temperature and/or the value of the second exhaust gas temperature and/or the value of the third exhaust gas temperature lies in the correspondingly assigned one of the individual third exhaust gas temperature value ranges.

FIG. 1e) illustrates the progression of the temperature T_{L} of the charge air versus the time t. It can be seen that a higher charge air temperature T_{L} is present in the second operating mode B2 than in the first operating mode B1. It may be necessary here to provide measures for cooling the charge air, for example a particularly efficient charge air cooler etc.

Viewing FIGS. 1d) and e) together, it can be seen that components and peripheral components of the internal combustion engine that come into contact or interact with the charge air and/or the exhaust gas are subject to greater load in the second operating mode B2 than in the first operating mode B1. This is however accepted in order to switch into the second operating mode as early as possible during the fired operation of the internal combustion engine and in order to operate the internal combustion engine in the second operating mode as often as possible/for as long as possible. This is because the second operating mode—that is to say the Miller cycle of first or low Miller intensity—offers advantages over the first operating mode B1 in terms of exhaust gas temperature. The components/peripheral components that interact with the exhaust gas—for example the turbine of the charge air compressor, the exhaust gas aftertreatment device, in particular the aftertreatment chamber thereof, etc.—thus come into contact with advantageously cool exhaust gas. Undesirably high temperatures, in particular the attainment of the specified threshold temperature(s), are thus effectively avoided. By means of the method, the internal combustion engine is operated with a stoichiometric fuel-air ratio λ=1, with an enrichment of the fuel-air mixture (λ<1) for the purposes of cooling the exhaust gas being intentionally dispensed with. If exhaust gas temperature(s) hotter than the threshold exhaust gas temperature(s) occur during the operation of the internal combustion engine, an enrichment of the fuel-air mixture (λ<1) for the purposes of cooling the exhaust gas is nevertheless dispensed with, and instead a switch is made into the third operating mode-that is to say into the Miller cycle of second or high Miller intensity. Thus, even at high loads, in particular during steady-state full load operation, the internal combustion engine is operated with a fuel-air ratio of λ=1, wherein the exhaust gas temperature or temperatures do not exceed the specified threshold exhaust gas temperature or temperatures.

Present legal requirements that stipulate particularly low limit values for pollutant emissions over an entire operating range of the internal combustion engine are adhered to.

The method for controlling the internal combustion engine, the control device configured for carrying out the method, the internal combustion engine, and the motor vehicle comprising the internal combustion engine, each provide a means for enabling an internal combustion engine to be operated particularly efficiently and with particularly low emissions.

### LIST OF REFERENCE SIGNS

1 Crankshaft
2 Working direction of rotation
KW1 First crankshaft angle
[KW1] First crankshaft angle range
KW2 Second crankshaft angle
[KW2] Second crankshaft angle range
KW3 Third crankshaft angle
[KW3] Third crankshaft angle range
TDC Top dead center position of the crankshaft
BDC Bottom dead center position of the crankshaft
B1 First operating mode
B2 Second operating mode or first Miller cycle
B3 Third operating mode or second Miller cycle
ES1 First intake valve spread angle
ES2 Second intake valve spread angle
ES3 Third intake valve spread angle
p_{L} Charge air pressure
Gp_{L} Threshold charge air pressure
T_{L} Charge air temperature

1.-11. (canceled)

12. A method for controlling an internal combustion engine that has a crankshaft, and an intake valve and a charge air compressor for pre-compressing charge air, the method comprising:
operating the internal combustion engine in a first operating mode if a first operating criterion is met, wherein in the first operating mode, proceeding from a top dead center position of the crankshaft and measured in a working direction of rotation of the crankshaft, a closure of the intake valve is fully completed at a first crankshaft angle at a bottom dead center position of the crankshaft in a first operating mode;
switching from the first operating mode into a second operating mode if a second operating criterion is met, wherein in the second operating mode, proceeding from the top dead center position of the crankshaft and measured in the working direction of rotation of the crankshaft, the closure of the intake valve is fully completed at a second crankshaft angle, which is smaller than the first crankshaft angle, before the bottom dead center position; and
switching from the second operating mode into ae third operating mode if a third operating criterion is met, wherein in the third operating mode, proceeding from the top dead center position of the crankshaft and measured in the working direction of rotation of the crankshaft, the closure of the intake valve is fully completed, at a third crankshaft angle, which is smaller than the second crankshaft angle, before the bottom dead center position.

13. The method as claimed in claim 12, wherein:
the first operating criterion is met upon meeting at least one of a group of sub-criteria consisting of:
a present charge air pressure has a value that lies in a first specified charge air pressure value range comprising values from zero up to and including a first specified threshold charge air pressure value;
a present crankshaft rotational speed has a value that lies in a first specified rotational speed value range comprising values from zero up to and including a first specified threshold rotational speed value;
a present load of the internal combustion engine has a value that lies in a first specified load value range comprising values from zero up to and including a first specified threshold load value;
a present transmission ratio stage of a multi-ratio speed-transforming transmission coupled to the internal combustion engine has a value that lies in a first specified transmission ratio stage value range comprising values from zero up to and including a first specified threshold transmission ratio stage value;
a present traveling speed of a motor vehicle that has the internal combustion engine as a drive machine has a value that lies in a first specified speed value range comprising values from zero up to and including a first specified threshold speed value;
a present operating duration for which the internal combustion engine was most recently operated in the first operating mode without interruption has a value that lies in a first specified time value range comprising values from zero up to and including a first specified threshold operating duration value;
at a location in an exhaust section of the internal combustion engine, an exhaust gas temperature is determined, a value of which lies in a first specified exhaust gas temperature value range comprising values from zero up to and including a first specified threshold exhaust gas temperature value.

14. The method as claimed in claim 13, wherein the determination of the exhaust gas temperature comprises a determination of a first exhaust gas temperature at a location in the exhaust section, said first location being assigned to a turbine of an exhaust gas turbocharger of the internal combustion engine.

15. The method as claimed in claim 13, wherein the determination of the exhaust gas temperature comprises a determination of a second exhaust gas temperature at a second location assigned to an inflow end of an exhaust gas aftertreatment device of the internal combustion engine.

16. The method as claimed in claim 13, wherein the measurement of the exhaust gas temperature comprises a measurement of a third exhaust gas temperature at a third location in the exhaust section assigned to an aftertreatment chamber, through which the exhaust gas flows, of a exhaust gas aftertreatment device.

17. The method as claimed in claim 13, wherein the second operating criterion is met upon meeting at least one of a group of second sub-criteria consisting of:
the present charge air pressure has a value that lies in a second specified charge air pressure value range comprising values from but excluding the first specified threshold charge air pressure value up to and including a second specified threshold charge air pressure value;
the present crankshaft rotational speed has a value that lies in a second specified rotational speed value range comprising values from but excluding the first specified threshold rotational speed value up to and including a second specified threshold rotational speed value;
the present load of the internal combustion engine has a value that lies in a second specified load value range comprising values from but excluding a first specified threshold load value up to and including a second specified threshold load value;
the present transmission ratio stage of the multi-ratio speed-transforming transmission coupled to the internal combustion engine has a value that lies in a second specified transmission ratio stage value range comprising values from but excluding the first specified threshold transmission ratio stage value up to and including a second specified threshold transmission ratio stage value;
the present traveling speed of a motor vehicle has a value that lies in a second specified speed value range comprising values from but excluding the first specified threshold speed value up to and including the second specified threshold speed value;
the present operating duration for which the internal combustion engine was most recently operated in the first operating mode without interruption has a value that lies in a second specified time value range comprising values from but excluding the first specified threshold operating time value up to and including the second specified threshold operating time value;
at the location in the exhaust section of the internal combustion engine, the exhaust gas temperature is determined, the value of which lies in a second specified exhaust gas temperature value range comprising values from but excluding the first specified threshold exhaust gas temperature value up to and including a second specified threshold exhaust gas temperature value.

18. The method as claimed in claim 17, wherein the second operating criterion is met upon meeting at least one of a further group of second sub-criteria consisting of:
the present charge air pressure value transitions from the first specified charge air pressure value range to second specified charge air pressure value range;
the present crankshaft rotational speed value transitions from the first specified rotational speed value range to the second specified rotational speed value range;
the present load value of the internal combustion engine transitions from the first specified load value range to the second specified load value range;
the present transmission ratio stage value transitions from the first specified transmission ratio stage value range to the second specified transmission ratio stage value range;
the present traveling speed value transitions from the first specified speed value range to the second specified speed value range;
at the location in the exhaust section of the internal combustion engine, the exhaust gas temperature is determined, the value of which transitions from the first specified exhaust gas temperature value range to the second specified exhaust gas temperature value range.

19. The method as claimed in claim 18, wherein the third operating criterion is met upon meeting at least one of a group of third sub-criteria consisting of:
the present charge air pressure has a value that lies in a third specified charge air pressure value range comprising values higher than but excluding the second specified threshold charge air pressure value;
the present crankshaft rotational speed has a value that lies in a third specified rotational speed value range comprising values higher than but excluding the second specified threshold rotational speed value;
the present load of the internal combustion engine has a value that lies in a third specified load value range comprising values higher than but excluding the second specified threshold load value range;
the present transmission ratio stage of the multi-ratio speed-transforming transmission has a value that lies in a third specified transmission ratio stage value range comprising values higher than but excluding the second specified threshold transmission ratio stage value;
the present traveling speed of the motor vehicle has a value that lies in a third specified speed value range comprising values higher than but excluding the second specified threshold speed value;
a present operating duration for which the internal combustion engine was most recently operated in the second operating mode without interruption has a value that lies in a third specified time value range comprising values higher than but excluding the second specified threshold operating duration value;
at the location in an exhaust section of the internal combustion engine, then exhaust gas temperature is determined, the value of which lies in a third specified exhaust gas temperature value range comprising values higher than but excluding the second specified threshold exhaust gas temperature value.

20. The method as claimed in claim 18, wherein the determination of the exhaust gas temperature comprises a determination of a first exhaust gas temperature at a location in the exhaust section, said first location being assigned to a turbine of an exhaust gas turbocharger of the internal combustion engine.

21. The method as claimed in claim 18, wherein the determination of the exhaust gas temperature comprises a determination of a second exhaust gas temperature at a second location assigned to an inflow end of an exhaust gas aftertreatment device of the internal combustion engine.

22. The method as claimed in claim 18, wherein the measurement of the exhaust gas temperature comprises a measurement of a third exhaust gas temperature at a third location in the exhaust section assigned to an aftertreatment chamber, through which the exhaust gas flows, of a exhaust gas aftertreatment device.

23. The method as claimed in claim 17, wherein the third operating criterion is met upon meeting at least one of a group of third sub-criteria consisting of:
the present charge air pressure has a value that lies in a third specified charge air pressure value range comprising values higher than but excluding the second specified threshold charge air pressure value;
the present crankshaft rotational speed has a value that lies in a third specified rotational speed value range comprising values higher than but excluding the second specified threshold rotational speed value;
the present load of the internal combustion engine has a value that lies in a third specified load value range comprising values higher than but excluding the second specified threshold load value range;
the present transmission ratio stage of the multi-ratio speed-transforming transmission has a value that lies in a third specified transmission ratio stage value range comprising values higher than but excluding the second specified threshold transmission ratio stage value;
the present traveling speed of the motor vehicle has a value that lies in a third specified speed value range comprising values higher than but excluding the second specified threshold speed value;
a present operating duration for which the internal combustion engine was most recently operated in the second operating mode without interruption has a value that lies in a third specified time value range comprising values higher than but excluding the second specified threshold operating duration value;
at the location in an exhaust section of the internal combustion engine, then exhaust gas temperature is determined, the value of which lies in a third specified exhaust gas temperature value range comprising values higher than but excluding the second specified threshold exhaust gas temperature value.

24. The method as claimed in claim 12, wherein the second operating criterion is met upon meeting at least one of a group of second sub-criteria consisting of:
a present charge air pressure has a value that lies in a second specified charge air pressure value range comprising values from but excluding a first specified threshold charge air pressure value up to and including a second specified threshold charge air pressure value;
a present crankshaft rotational speed has a value that lies in a second specified rotational speed value range comprising values from but excluding a first specified threshold rotational speed value up to and including a second specified threshold rotational speed value;
a present load of the internal combustion engine has a value that lies in a second specified load value range comprising values from but excluding a first specified threshold load value up to and including a second specified threshold load value;
a present transmission ratio stage of a multi-ratio speed-transforming transmission coupled to the internal combustion engine has a value that lies in a second specified transmission ratio stage value range comprising values from but excluding a first specified threshold transmission ratio stage value up to and including a second specified threshold transmission ratio stage value;
a present traveling speed of a motor vehicle that has the internal combustion engine as a drive machine has a value that lies in a second specified speed value range comprising values from but excluding a first specified threshold speed value up to and including a second specified threshold speed value;
a present operating duration for which the internal combustion engine was most recently operated in the first operating mode without interruption has a value that lies in a second specified time value range comprising values from but excluding a first specified threshold operating time value up to and including a second specified threshold operating time value;
at a location in an exhaust section of the internal combustion engine, an exhaust gas temperature is determined, the value of which lies in a second specified exhaust gas temperature value range comprising values from but excluding a first specified threshold exhaust gas temperature value up to and including a second specified threshold exhaust gas temperature value.

25. The method as claimed in claim 12, wherein:
the first crankshaft angle and the second crankshaft angle are spaced apart by a first angular interval of in particular greater than 10° or greater than 30°, or
the second crankshaft angle and the third crankshaft angle are spaced apart by a second angular interval of in particular greater than 5°.

26. The method as claimed in claim 12, wherein:
the first crankshaft angle and the second crankshaft angle are spaced apart by a first angular interval of in particular greater than 10° or greater than 30°, and
the second crankshaft angle and the third crankshaft angle are spaced apart by a second angular interval of in particular greater than 5°.

27. A control device for an internal combustion engine, wherein the control device is configured to carry out the method configured as claimed in claim 12.

28. An internal combustion engine unit having an internal combustion engine and having the control device as claimed in claim 27, and which is coupled or couplable to control the internal combustion engine.

29. A motor vehicle having the internal combustion engine unit configured as claimed in claim 28.
